(19) United States
(12) Patent Application Publication
(10) Pub. No.: US 2007/0030603 A1
(43) Pub. Date: Feb. 8, 2007

(54) Stabilizer for magnetoresistive head in current perpendicular to plane mode and method of manufacture

(76) Inventors: Isamu Sato, Tokyo (JP); Rachid Sbiaa, Tokyo (JP)

Correspondence Address: SUGHRUE MION, PLLC, 2100 PENNSYLVANIA AVENUE, N.W., SUITE 800, WASHINGTON, DC, 20037, US

(21) Appl. No.: 10/572,071

(22) PCT Filed: Apr. 2, 2004
(86) PCT No.: PCT/JP04/04841

§ 371 Date: Mar. 15, 2006

(51) Int. Cl. G11B 5/33; G11B 5/127

(52) U.S. Cl. 360/324; 29/603.14

(57) ABSTRACT

A reader of a magnetoresistive head includes a spin valve with sensor having a stabilizing hard bias and side shield at the side of the sensor, to substantially reduce the undesired flux from adjacent bits and tracks. At least one free layer is spaced apart from at least one pinned layer by a spacer. Above the free layer, a capping layer is provided. The stabilizer may include an insulator, a soft material that is a shielding layer, a decoupling layer, and a hard bias. As a result, the free layer is shielded from the undesired flux of adjacent tracks, and recording media having substantially smaller track size and bit size can be used.

### TECHNICAL FIELD

The present invention relates to a read element of a magnetoresistive (MR) head including a sensor having stabilizers on its sides, and a method of manufacture therefor. More specifically, the present invention relates to a spin valve of an MR read element having a multi-layer stabilizer that includes a hard bias combined with a soft material serving as side shield.

### BACKGROUND ART

In the related art magnetic recording technology such as hard disk drives, a head is equipped with a reader and a writer. The reader and writer have separate functions and operate independently of one another.

FIGS. 1 (a) and (b) illustrate related art magnetic recording schemes. In FIG. 1(a), a recording medium 1 having a plurality of bits 3 and a track width 5 has a magnetization parallel to the plane of the recording media. As a result, a magnetic flux is generated at the boundaries between the bits 3. This is also commonly referred to as “longitudinal magnetic recording media” (LMR).

Information is written to the recording medium 1 by an inductive write element 9, and data is read from the recording medium 1 by a read element 11. A write current 17 is supplied to the inductive write element 9, and a read current is supplied to the read element 11.

The read element 11 is a magnetic sensor that operates by sensing the resistance change as the sensor magnetization direction changes from one direction to another direction. A shield 13 is also provided to reduce the undesirable magnetic fields coming from the media and prevent the undesired flux of adjacent bits from interfering with the one of the bits 3 that is currently being read by the read element 11.

The area density of the related art recording medium 1 has increased substantially over the past few years, and is expected to continue to increase substantially. Correspondingly, the bit and track densities are expected to increase. As a result, the related art reader must be able to read this data having increased density at a higher efficiency and speed.

In the related art, the density of bits has increased much faster than the track density. However, the aspect ratio between bit size and track size is decreasing. Currently, this factor is about 8, and it is estimated that in the future, this factor will decrease to 6 or less as recording density approaches terabyte size.

As a result, the track width is becoming so small that the magnetic field from the adjacent tracks, and not just the adjacent bits, will affect the read sensor. Table 1 shows the estimated scaling parameters based on these changes.

TABLE 1

| Areal | bit | track | bit aspect | bit | read track | Track |
|---|---|---|---|---|---|---|
| Density | density | density | ratio | length | width | pitch |
| Gbpsi | (Mbpi) | (ktpi) | (bit/track) | nm | nm | nm |
| 200 | 1.2 | 160 | 7.5 | 20 | 100 | 150 |
| 400 | 1.8 | 222 | 8.1 | 14.1 | 76 | 110 |
| 600 | 2 | 300 | 6.7 | 12.7 | 55 | 85 |
| 1000 | 2.5 | 380 | 6.5 | 9.7 | 45 | ˜? |

Another related art magnetic recording scheme has been developed as shown in FIG. 1(b). In this related art scheme, the direction of magnetization 19 of the recording medium 1 is perpendicular to the plane of the recording medium. This is also known as “perpendicular magnetic recording media” (PMR).

This PMR design provides more compact and stable recorded data. However, with PMR media the transverse field coming from the recording medium, in addition to the above-discussed effects of the neighboring media tracks, must also be considered. This effect is discussed below with respect to FIG. 6(b).

The flux is highest at the center of the bit, decreases toward the ends of the bit and approaches zero at the ends of the bit. As a result, there is a strong transverse component to the recording medium field at the center of the bit, in contrast to the above-discussed LMR scheme, where the flux is highest at the edges of the bits.

FIGS. 2(a)-(c) illustrate various related art read sensors for the above-described magnetic recording scheme, also known as “spin valves”. In the bottom type spin valve illustrated in FIG. 2(a), a free layer 21 operates as a sensor to read the recorded data from the recording medium 1. A spacer 23 is positioned between the free layer 21 and a pinned layer 25. On the other side of the pinned layer 25, there is an anti-ferromagnetic (AFM) layer 27.

In the top type spin valve illustrated in FIG. 2(b), the position of the layers is reversed. FIG. 2(c) illustrates a related art dual type spin valve. Layers 21 through 25 are substantially the same as described above with respect to FIGS. 2(a)-(b). An additional spacer 29 is provided on the other side of the free layer 21, upon which a second pinned layer 31 and a second AFM layer 33 are positioned. The dual type spin valve operates according to the same principle as described above with respect to FIGS. 2(a)-(b)

In the read head based on the MR spin valve, the magnetization of the pinned layer 25 is fixed by exchange coupling with the AFM layer. Only the magnetization of the free layer 21 can rotate according to the media field direction.

In the recording media 1, flux is generated based on polarity of adjacent bits. If two adjoining bits have negative polarity at their boundary the flux will be negative, and if both of the bits have positive polarity at the boundary the flux will be positive. The magnitude of flux determines the angle of magnetization between the free layer and the pinned layer.

When the magnetizations of the pinned and free layers are in the same direction, then the resistance is low. On the other hand, when their magnetizations are in opposite directions the resistance is high. In the MR head application, when no external magnetic field is applied, the free layer 21 and pinned layer 25 have their magnetizations at 90 degrees with respect to each other.

If the spin polarization of the ferromagnetic layer is low, electron spin state can be more easily changed, in which case a small resistance change can be measured. On the other hand, if the ferromagnetic layer spin polarization is high electrons crossing the ferromagnetic layer can keep their spin state and high resistance change can be achieved. Therefore, there is a related art need to have a high spin polarization material.

When an external field (flux) is applied to a reader, the magnetization of the free layer 21 is altered, or rotated by an angle. When the flux is positive the magnetization of the free layer is rotated upward, and when the flux is negative the magnetization of the free layer is rotated downward. Further, if the applied external field results in the free layer 21 and the pinned layer 25 having the same magnetization direction, then the resistance between the layers is low, and electrons can more easily migrate between those layers 21, 25.

However, when the free layer 21 has a magnetization direction opposite to that of the pinned layer 25, the resistance between the layers is high. This is because it is more difficult for electrons to migrate between the layers 21, 25.

Similar to the external field, the AFM layer 27 provides an exchange coupling and keeps the magnetization of pinned layer 25 fixed. The properties of the AFM layer 27 are due to the nature of the materials therein. In the related art, the AFM layer 27 is usually PtMn or IrMn.

The resistance change ΔR between the states when the magnetizations of layers 21, 25 are parallel and anti-parallel should be high to have a highly sensitive reader. As head size decreases, the sensitivity of the reader becomes increasingly important, especially when the magnitude of the media flux is decreased. Thus, there is a need for high resistance change ΔR between the layers 21, 25 of the related art spin valve.

A summary of the related art spin valve concepts is provided herein. When a polarized electron meets a ferromagnetic film, the electron is harmed by the magnetic moments and scattered. The loss of electron energy is transferred to the magnetic moment, based on the law of conservation of energy. This transfer of energy is manifested as torque, which acts on the ferromagnetic film. As noted above, the magnetization of the free layer may be perturbed and even switch under certain conditions such as high current density, low magnetization, thin magnetic film and other intrinsic parameters, including exchange stiffness and damping factor.

In the related art spin valve, when the free layer has a sufficiently small magnetization, the resistance of its magnetization to energy transfer (momentum transfer) is weak, and its magnetization direction can be changed. Further, when the exchange stiffness (exchange energy between a magnetic moment and its neighbor) is small, some moments will switch before others.

For a CPP-GMR spin valve with a current flowing through the film thickness, the pinned layer acts as a polarizing layer (source of polarization) because its magnetization does not change due to strong exchange coupling with AFM layer.

FIG. 6(a) graphically shows the foregoing principle for the related art longitudinal magnetic recording scheme illustrated in FIG. 1(a). As the media spins, the flux at the boundary between bits acts to the free layer which magnetization rotates upward and downward according to the related art spin valve principles.

FIG. 6(b) illustrates the related art perpendicular magnetic recording, with the effect of the field generated by the bit itself. Additionally, a related art intermediate layer (not shown) between the recording layer and a soft underlayer 20 of the perpendicular recording medium may also be provided. The intermediate layer provides improved control of exchange coupling between the layers.

U.S. Patent publication nos. 2002/0167768 and 2003/0174446, the contents of which are incorporated herein by reference, disclose side shields to avoid flux generated by adjacent tracks, along with an in-stack bias.

In addition to the foregoing related art spin valve in which the pinned layer is a single layer, FIG. 3 illustrates a related art synthetic spin valve. The free layer 21, the spacer 23 and the AFM layer 27 are substantially the same as described above. In this figure only one state of the free layer is illustrated. However, the pinned layer further includes a first sublayer 35 separated from a second sublayer 37 by a spacer 39.

In the related art synthetic spin valve, the first sublayer 35 operates according to the above-described principle with respect to the pinned layer 25. Additionally, the second sublayer 37 has an opposite spin state with respect to the first sublayer 35. As a result, the pinned layer total moment is reduced due to anti-ferromagnetic coupling between the first sublayer 35 and the second sublayer 37. A synthetic spin-valve head has a pinned layer with a total flux close to zero, high resistance change DR and greater stability, and high pinning field can be achieved.

FIG. 4 illustrates the related art synthetic spin valve with a shielding structure. As noted above, it is important to avoid unintended magnetic flux from adjacent bits from being sensed during the reading of a given bit. A top shield 43 is provided on an upper surface of the free layer 21. Similarly, a bottom shield 45 is provided on a lower surface of the AFM layer 27. The effect of the shield system is shown in and discussed with respect to FIG. 6.

As shown in FIGS. 5(a)-(d), there are four related art types of spin valves. The type of spin valve structurally varies based on the structure of the spacer 23.

The related art spin valve illustrated in FIG. 5(a) uses the spacer 23 as a conductor, and is used for the related art CIP scheme illustrated in FIG. 1(a) for a giant magnetoresistance (GMR) type spin valve where the current is in-plane-to the film.

In the related art GMR spin valve, resistance is minimized when the magnetization directions (or spin states) of the free layer 21 and the pinned layer 25 are parallel, and is maximized when the magnetization directions are opposite. As noted above, the free layer 21 has a magnetization direction that can be changed. Thus, the GMR system avoids perturbation of the head output signal by minimizing the undesired switching of the pinned layer magnetization.

GMR depends on the degree of spin polarization of the pinned and free layers, and the angle between their magnetic moments. Spin polarization depends on the difference between the number of electrons in spin state up and down normalized by the total number of electron in conduction band in each of the free and pinned layers. These concepts are discussed in greater detail below.

As the free layer 21 receives the flux that signifies bit transition in case of LMR, the free layer spin rotates by a small angle in one direction or the other, depending on the direction of flux. The change in resistance between the pinned layer 25 and the free layer 21 is proportional to angle between the moments of the free layer 21 and the pinned layer 25. There is a relationship between resistance change ΔR and reproduced signal output of the reader.

The GMR spin valve has various requirements. For example, but not by way of limitation, a large resistance change ΔR is required to generate a high output signal. Further, low coercivity is desired, so that small media fields can also be detected. With high pinning field strength, the AFM structure is well defined, and when the interlayer coupling is low, the sensing layer is not adversely affected by the pinned layer. Further, low magnetistriction is desired to minimize stress on the free layer.

In order to increase the recording density, the track width of the GMR sensor must be made smaller. In this aspect read head operating in CIP scheme (current-in-plane), various issues arise as the size of the sensor decreases. The magnetoresistance (MR) in CIP mode is generally limited to about 20%. When the electrode connected to the sensor is reduced in size overheating results and may potentially damage the sensor, as can be seen from FIG. 7(a). Further, the signal available from CIP sensor is proportional to the MR head width.

To address the foregoing issues and as shown in FIG. 7(b), related art CPP-GMR scheme is using a sense current that flows in a direction perpendicular to the spin valve plane. In CPP mode, the signal increases as the sensor width is reduced. Various related art spin valves that operate in the CPP scheme are illustrated in FIGS. 5(b)-(d), and are discussed in greater detail below.

FIG. 5(b) illustrates a related art tunneling magnetoresistive (TMR) spin valve for a CPP scheme. In the TMR spin valve, the spacer 23 acts as an insulator, or tunnel barrier layer. Thus, electrons can tunnel from free layer to pinned layer through the insulator barrier 23. TMR spin valves have an increased MR on the order of about 30-50%.

FIG. 5(c) illustrates a related art CPP-GMR spin valve. While the general concept of GMR is similar to that described above with respect to CIP-GMR, the current is flowing perpendicular to the plane, instead of in-plane. As a result, the resistance change ΔR and the intrinsic MR are substantially higher than the CIP-GMR.

In the related art CPP-GMR spin valve, there is a need for a large ΔR*A (A is the area of the MR element) and a moderate head resistance. A low free layer coercivity is required so that a small media field can be detected. The pinning field should also have a high strength.

FIGS. 7(a)-(b) illustrate the structural difference between the CIP and CPP GMR spin valves. As shown in FIG. 7(a), there is a hard bias 998 on the sides of the GMR spin valve, with an electrode 999 on upper surfaces of the GMR. Gaps 997 are also required. As shown in FIG. 7(b), in the CPP-GMR spin valve, an insulator 1000 is deposited at the side of the spin valve that the sensing current can only flow in the film thickness direction. Further, no gap is needed in the CPP-GMR spin valve.

As a result, the current has a much larger surface through which to flow, and the shield also serves as an electrode. Hence, the overheating issue is substantially addressed.

FIG. 5(d) illustrates the related art ballistic magnetoresistance (BMR) spin valve. In the spacer 23, which operates as an insulator, a ferromagnetic layer region 47 connects the pinned layer 25 to the free layer 21. The area of contact is on the order of a few nanometers. As a result, there is a substantially higher MR due to electrons scattering at the domain wall created within this nanocontact. Other factors include the spin polarization of the ferromagnets, and the structure of the magnetic domain that is in nano-contact with the BMR spin valve.

However, the related art BMR spin valve is in early development, and is not in commercial use. Further, for the BMR spin valve the nano-contact shape and size controllability and stability of the domain wall must be further developed. Additionally, the repeatability of the BMR technology is yet to be shown for high reliability.

In the foregoing related art spin valves of FIGS. 5(a)-(d), the spacer 23 of the spin valve is an insulator for TMR, a conductor for GMR, and an insulator having a magnetic nano-sized connector for BMR. While related art TMR spacers are generally made of more insulating metals such as alumina, related art GMR spacers are generally made of more conductive metals, such as copper. Accordingly, there is a need to address the foregoing issues of the related art.

### DISCLOSURE OF INVENTION

It is an object of the present invention to overcome at least the aforementioned problems and disadvantages of the related art. However, it is not necessary for the present invention to overcome those problems and disadvantages, nor any problems and disadvantages.

To achieve at least this object and other objects, a device for reading a recording medium and having a spin valve is provided that includes a magnetic sensor. Further, the sensor includes a free layer having an adjustable magnetization direction in response to a flux received from the recording medium, and a pinned layer having a fixed magnetization stabilized in accordance with an antiferromagnetic (AFM) layer positioned on a surface of the pinned layer opposite a spacer sandwiched between the pinned layer and the free layer. The sensor also includes a buffer sandwiched between the AFM layer and a bottom shield that shields undesired flux at a first outer surface of the magnetic sensor, and a capping layer sandwiched between the free layer and a top shield that shields undesired flux at a second outer surface of the magnetic sensor. Additionally, a stabilizer is provided that includes a hard bias region and a soft shield region, wherein the stabilizer is positioned on sides of the magnetic sensor and separated from the magnetic sensor by an insulator layer.

Also, a method of fabricating a magnetic sensor is provided, including the step of on a wafer, forming a free layer having an adjustable magnetization direction in response to a flux received from the recording medium, a pinned layer having a fixed magnetization direction by exchange coupling with an antiferromagnetic (AFM) layer positioned on a surface of the pinned layer opposite a spacer sandwiched between the pinned layer and the free layer, a buffer sandwiched between the AFM layer and a bottom shield that shields undesired flux at a first outer surface of the magnetic sensor, and a capping layer on the free layer. The method also includes the steps of forming a first mask on a first region on the capping layer, performing a first ion milling step to generate a sensor region, and depositing an insulator thereon and removing the first mask. Additional steps in the method include forming a second mask on predetermined portions of the first region, performing a second ion milling step to generate a shape of the magnetic sensor, depositing a stabilizer having a hard bias region and a soft shield region onto sides of the magnetic sensor, and then removing the second mask, and forming a top shield on the capping layer and the first stabilizing layer.

### BRIEF DESCRIPTION OF DRAWINGS

The above and other objects and advantages of the present invention will become more apparent by describing in detail preferred exemplary embodiments thereof with reference to the accompanying drawings, wherein like reference numerals designate like or corresponding parts throughout the several views, and wherein:

FIGS. 1(a) and (b) illustrates a related art magnetic recording scheme having in-plane and perpendicular-to-plane magnetization, respectively;

FIGS. 2(a)-(c) illustrate related art bottom, top and dual type spin valves;

FIG. 3 illustrates a related art synthetic spin valve;

FIG. 4 illustrates a related art synthetic spin valve having a shielding structure;

FIGS. 5(a)-(d) illustrates various related art magnetic reader spin valve systems;

FIGS. 6(a)-(b) illustrate the operation of a related art GMR sensor system;

FIGS. 7(a)-(b) illustrate related art CIP and CPP GMR systems, respectively; and

FIG. 8 illustrates a spin valve according to an exemplary, non-limiting embodiment of the present invention;

FIG. 9 illustrates a spin valve according to another exemplary, non-limiting embodiment of the present invention;

FIG. 10 illustrates a spin valve according to yet another exemplary, non-limiting embodiment of the present invention;

FIG. 11 illustrates a spin valve according to another exemplary, non-limiting embodiment of the present invention;

FIG. 12 illustrates a spin valve according to another exemplary, non-limiting embodiment of the present invention;

FIG. 13 illustrates a spin valve according to another exemplary, non-limiting embodiment of the present invention; and

FIG. 14 illustrates a flowchart for an exemplary, non-limiting method of manufacturing at least one embodiment of the present invention.

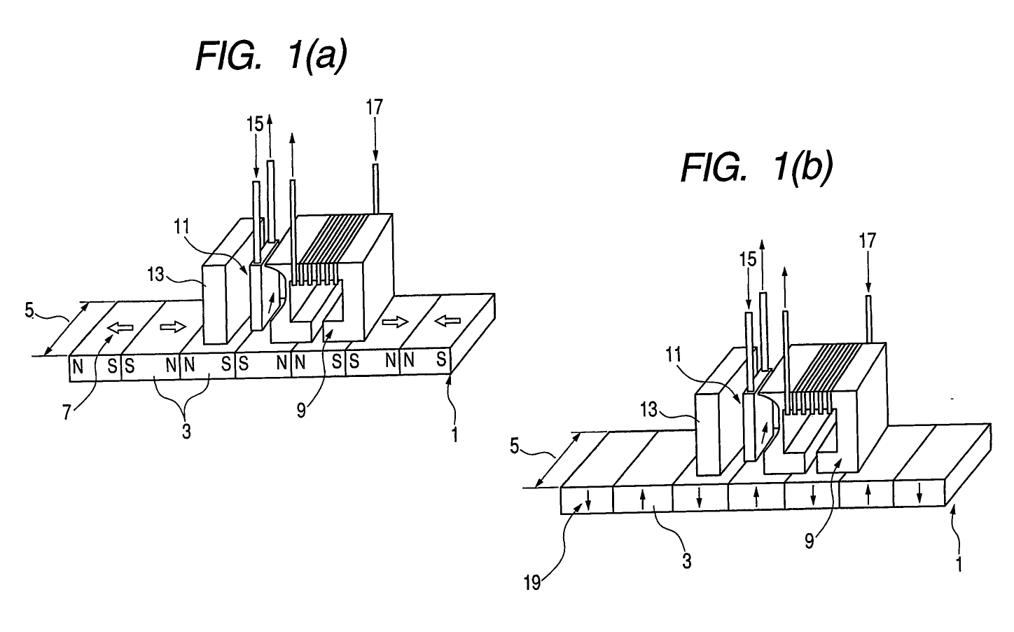

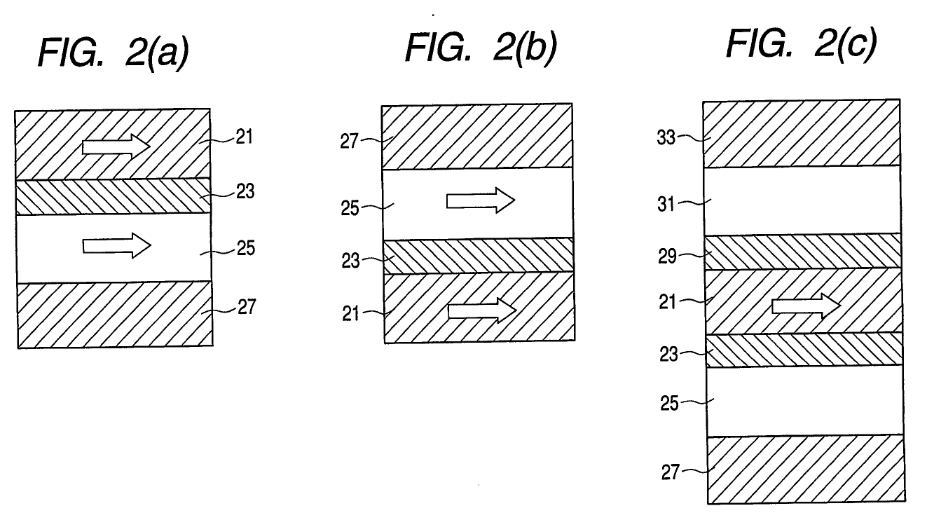

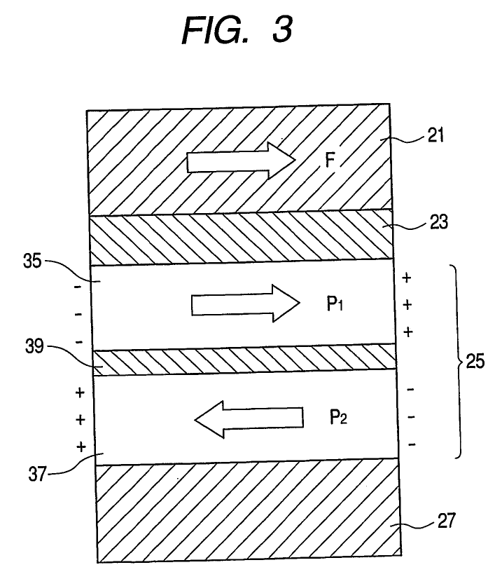

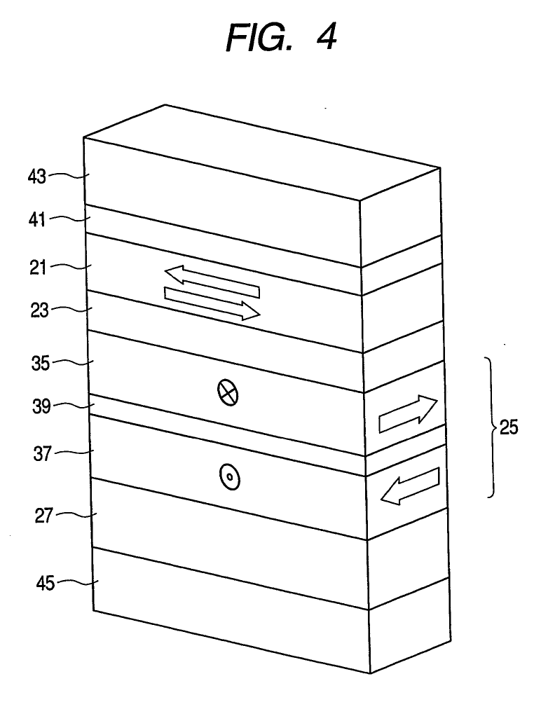

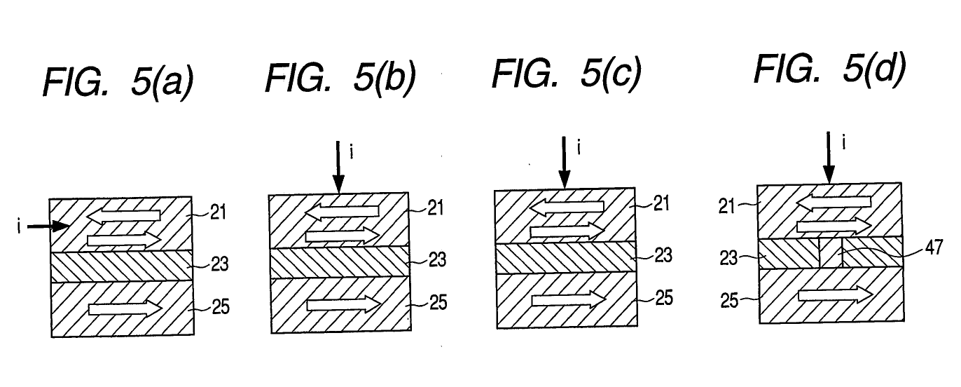

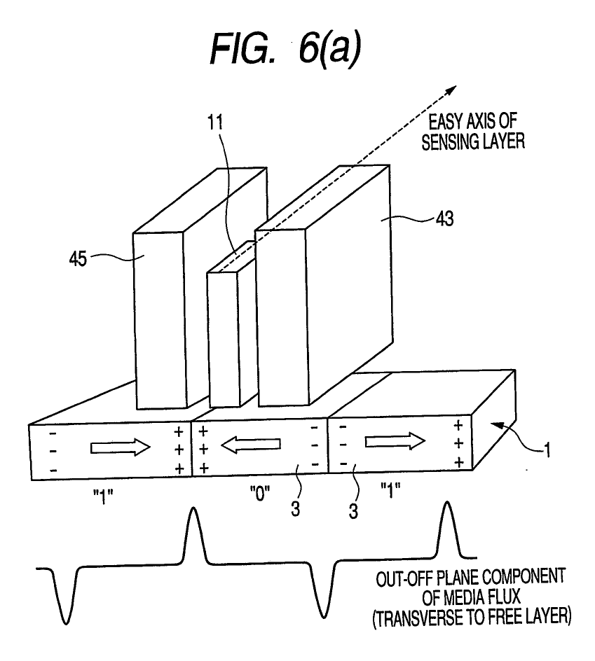

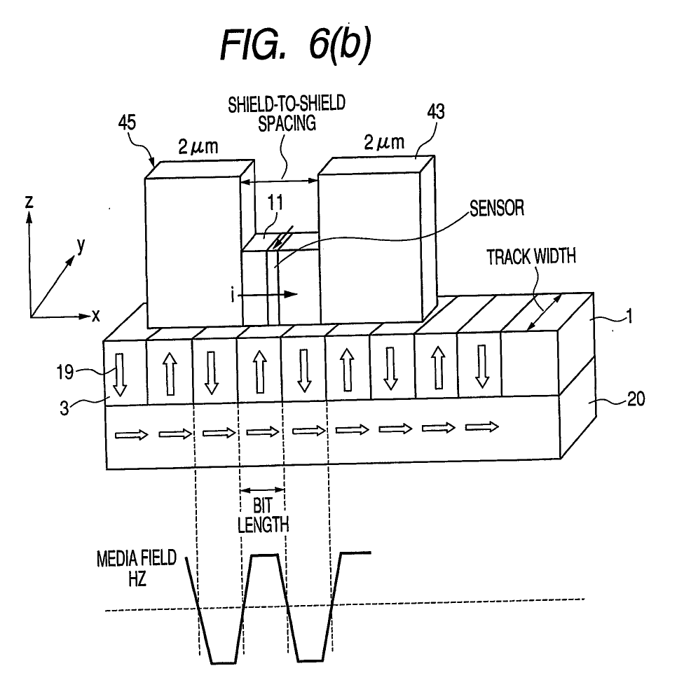

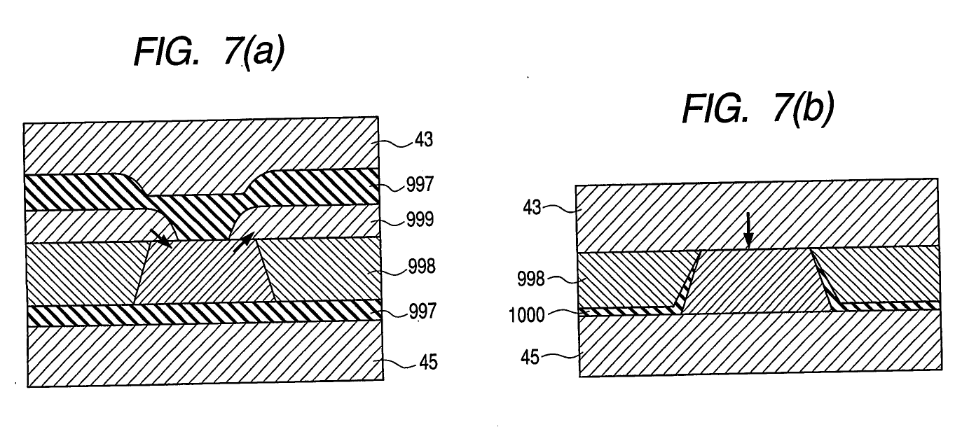

### MODES FOR CARRYING OUT THE INVENTION

Referring now to the accompanying drawings, description will be given of preferred embodiments of the invention. Substantially similar elements of subsequent embodiments will not be repeated where those elements were already discussed with respect to a previous embodiment.

The present invention relates to a magnetoresistive sensor design for a reading head. More specifically, a hard bias is combined with a soft magnetic layer used as side shield to overcome at least the foregoing related art problem of undesired flux from adjacent tracks. The present invention uses a multilayer structure that includes a hard material (hard bias layer) and soft material (soft shield layer). The soft shield layer has a high permeability to avoid the magnetic flux from adjacent tracks, and the hard bias layer is optionally decoupled from soft layer by a thin, non-magnetic spacer, preferably an insulator.

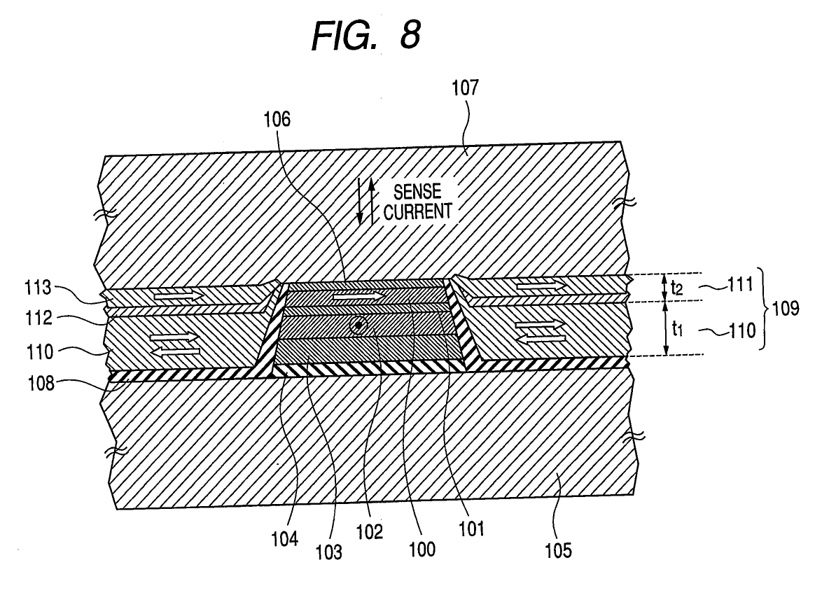

FIG. 8 illustrates a spin valve of a sensor for reading a magnetic medium according to an exemplary, non-limiting embodiment of the present invention. A spacer 101 is positioned between a free layer 100 and a pinned layer 102. As discussed above with respect to the related art, an external field is applied to the free layer 100 by a recording tedium, such that the magnetic field can be changed. The pinned layer 102 has a fixed magnetization direction.

The pinned layer 102 can be a single or synthetic pinned layer, and has a thickness of about 2 nm to about 10 nm. The free layer 100 is made from a material having at least one of Co, Fe and Ni, and has a thickness below about 5 nm. Alternatively or in combination with the foregoing materials, the free layer 100 and/or the pinned layer 102 may be made partially of a material that includes, but is not limited to, Fe₃O₄, CrO₂, NiFeSb, NiMnSb, PtMnSb, MnSb, La_{0.7}Sr_{0.3}MnO₃, Sr₂FeMoO₆ and SrTiO₃.

An anti-ferromagnetic (AFM) layer 103 is positioned on a lower surface of the pinned layer 102, and a buffer 104 is positioned on a lower surface of the AFM layer 103. A bottom shield 105 is provided below the buffer 104. Above the free layer 100, a capping layer 106 is provided, with a top shield 107 thereon.

The stabilizer of this exemplary, non-limiting embodiment of the present invention will now be described in greater detail. An insulator 108 is placed on the sides of the sensor and an upper surface of the bottom shield 105. Above the insulator layer 108, a multi-layer stabilizer 109 having a first layer 110 with a thickness t1 and a second layer 111 with a thickness t2 are positioned. The value of each of t1 and t2 can vary between about 1 nm and about 20 nm.

The first layer 110 is a shielding layer that includes soft material, and the second layer 111 includes a decoupling thin film layer 112 sandwiched between the shielding layer 110 and a hard bias layer 113. The hard bias layer 113 and the soft layer 110 are made of materials that are metallic, or a high resistive material, respectively.

The decoupling thin film layer 112 reduces the exchange coupling between the soft layer 110 and the hard bias layer 113, and is made from a non-magnetic material. For example, but not by way of limitation, a conductive, semiconductor or insulator may be used. The top shield 107 is provided above upper surfaces of the hard bias layer 113, the insulator 108 and the capping layer 106.

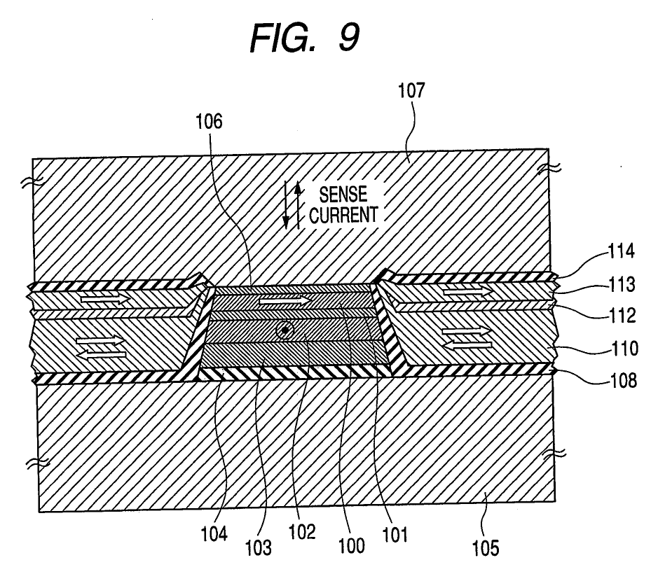

In another exemplary, non-limiting embodiment of the present invention shown in FIG. 9, a second insulator layer 114 is deposited on an upper surface of the hard bias layer 113. The second insulator layer 114 contacts the first insulator 108 at its inner end. As a result, current leakage between the stabilizer 109 and the MR sensor is substantially avoided. This is because shield to shield spacing is continuously reduced and avoiding current leakage by only insulator layer 108 might be difficult. All of the remaining elements of the embodiment illustrated in FIG. 9 are the same as those described above with respect to FIG. 8, and are thus not repeated here.

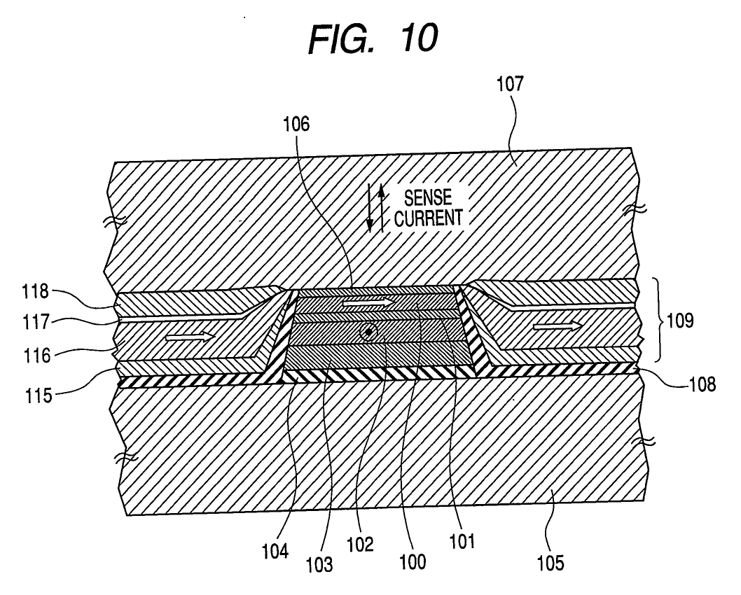

In yet another exemplary, non-limiting embodiment of the present invention shown in FIG. 10, the hard bias layer is grown on a soft underlayer. Such a structure provides favorable growth conditions and results in a hard bias having desirable properties, including (but not limited to) high coercivity.

In this exemplary, non-limiting embodiment, the discussion of the elements similar to the structure of FIGS. 8-9 is not repeated here. However, in this embodiment, a bias layer 116 is deposited before the soft shielding layer 118, as described in greater detail below.

On the insulator layer 108, a soft underlayer 115 is provided, upon which a hard bias layer 116 is positioned. The soft underlayer 115 has a high permeability, and thus provides desirable growth conditions and suppresses magnetic flux generated by the track. A decoupling layer 117 is provided above the hard bias layer 116, and a soft layer 118 is provided on the decoupling layer 117. The soft layer 118 has a high permeability, and provides side shielding of undesired flux from adjacent tracks. The top shield 107 is then positioned upon the upper surface of the soft layer 118, the insulator 108 and the capping layer 106.

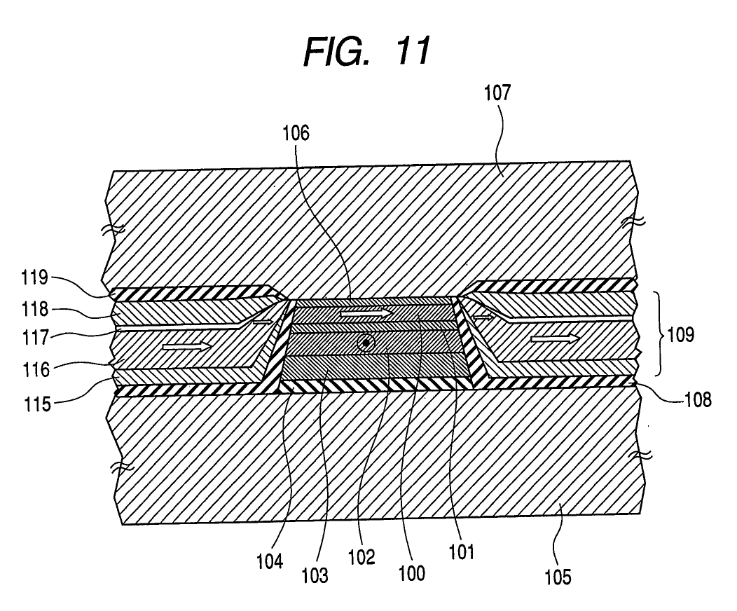

As shown in FIG. 11, as an alternate embodiment of that illustrated in FIG. 10, an additional insulating layer 119 may be added above the soft layer. This additional insulating layer 119 substantially prevents current leakage between the stabilizer 109 and the MR sensor. The elements similar to those in FIGS. 8-10 are not repeated here.

While the first insulator 108 may be made from a number of materials, it is preferably made of a material that promotes growth of the hard bias layer 116. For example, but not by way of limitation, TaO, which is both a good insulator and a good buffer for the hard bias layer 116, can be used for the insulator 108. However, the present invention is not limited to TaO for the insulator 108, and other materials that those skilled in the art would know to use may be substituted therefor.

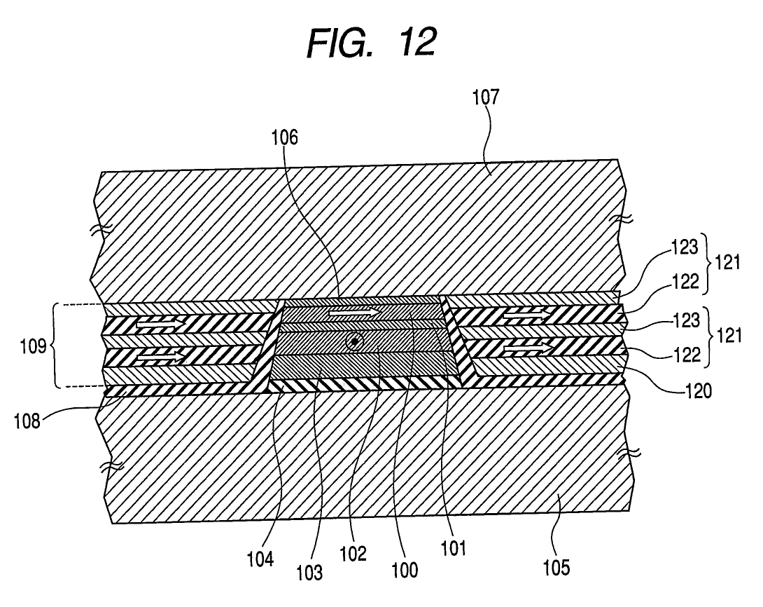

FIG. 12 illustrates yet another exemplary, non-limiting embodiment of the present invention. While the same MR sensor and insulator 108 are used as in the foregoing embodiments illustrated in FIGS. 8-11, a different stabilizer 109 is provided. The stabilizer 109 includes a multi-layer structure 121 having a soft underlayer 120 on the insulator 108 to promote crystallographic growth of a hard layer 122 on the soft underlayer 120. A soft layer 123 is then deposited on the hard layer 122, and this soft/hard multi-layer combination 121 is deposited thereon multiple times, such that the soft layer 123 is provided at the top and has an upper surface that contacts the top shield 107, along with the insulator 108 and the capping layer 106.

The foregoing multi-layer structure 121 is made from a high-permeability soft material such as (but not limited to) NiFe, and a hard material such as (but not limited to) CoPt. As a result of the multi-layer stabilizer structure, undesired flux from adjacent tracks is substantially reduced and as a result, the free layer of the MR sensor is further stabilized.

If the exchange coupling between the soft layer and the hard layer is high, the instrinsic parameters of both layers, as well as the softness of the soft layer are affected. Therefore, it is beneficial to control this exchange coupling.

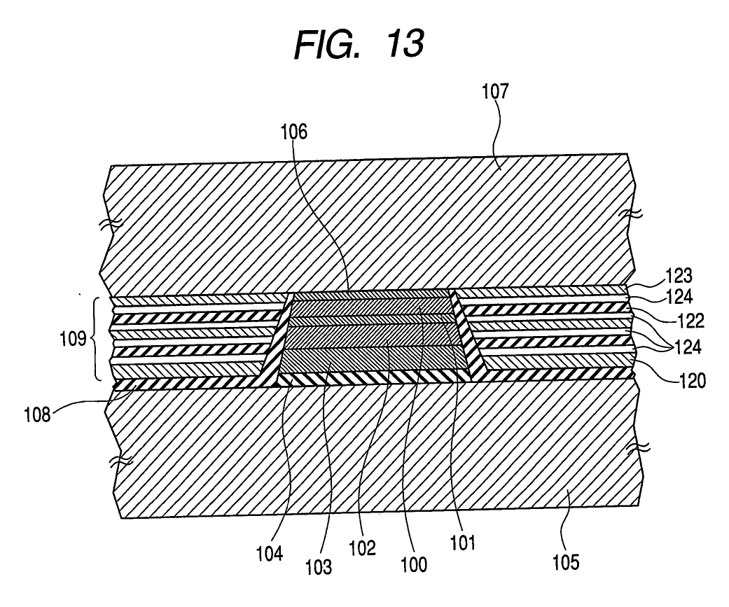

As an alternative embodiment of the foregoing, non-exemplary embodiment illustrated in FIG. 12, an intermediate non-magnetic decoupling layer 124 is sandwiched between the hard layer 122 and the soft layer 123 of the multi-layer combination 121, as shown in FIG. 13. This intermediate layer 124 results in a reduced exchange coupling between the hard layer 122 and the soft layer 123. As a result, the softness of the soft layer 123, which may be made of NiFe but is not limited thereto, is substantially not affected. This exchange coupling depends on a number of factors, including deposition conditions, interface properties and layer thickness. Accordingly, the introduction of this intermediate layer 124 reduces the exchange coupling.

The thin decoupling layer 124 is made from insulator, conductor or semiconductor materials. Alternatively to depositing such a layer, the decoupling between soft and hard layers can be performed by treating these layers. For example, but not by way of limitation, a small amount of oxygen can be flowed between the hard layer and the soft layer for a short time to generate a surfactant.

As noted above, the hard layer materials are at least one of metallic and insulating. While the hard layer in the foregoing multi-layer structures is disclosed to be made of CoPt, the present invention is not limited thereto. For example, but not by way of limitation, CoPtCr or CoPtCr—X, where X is at least one B, O, Ag, and other elements with similar properties may be substituted therein. The foregoing materials may also be used in combination with oxygen provided in a concentration between about 10% and about 40%. Alternatively, a highly resistive material such as γ-Fe₂O₃ and/or γ-(FeCo)₂O₃ may be used.

The soft layer is made of a material that is at least one of conductive and highly resistive. For example, but not by way of limitation, a conductive material such NiFe, FeSi, FeAlSi, CoZr, CoZrRe and/or Fe-M-B (where M=an element from group IVA and/or group VA of the periodic table of elements) maybe used. Further, a highly resistive material such as FeSiZr—O, FeAl—O, Fe—X—O (X=Zr, Hf), FeCoN, FeN, Fe—X—B—O, Fe—X—O (where X=Zr and/or Hf), FeCr—O and/or FeCr-M-O (where M=Cu, Rh) maybe used. However, the present invention is not limited thereto, and any equivalent of the foregoing materials as would be contemplated by those of ordinary skill in the art may be substituted therefor.

The decoupling layer is made of at least one of Al₂O₃, Si₃N₄, SiO₂, Cr, Ta, Cu and any non-magnetic material that is conductive or an insulator.

While the MR sensor as described above has a single pinned layer, the present invention is not limited thereto. For example, but not by way of limitation, the pinned layer of the MR sensor may also be a synthetic type pinned layer described above, including antiferromagnetically coupled bilayers. The pinned layer 102 has a thickness of about 2 nm to about 100 nm.

In the present invention, the sense current flows in the direction perpendicular to the film plane, i.e., in the film thickness direction. As a result, the spacer 101 is conductive when the spin valve is used in CPP-GMR applications. Alternatively, for TMR applications, the spacer 101 is insulative (for example but not by way of limitation, Al₂O₃). When a connecting is provided as discussed above with respect to the related art, a BMR-type head may be provided, where nanocontact connections of less than about 30 nm is provided in an insulator matrix. As yet another alternative, the spacer 101 may be a mixture of a conductive and insulative material between said pinned layer and said free layer for use in a current heterogeneous spacer or current confinement path (CCP)-CPP spin valve.

Additionally, while only top and bottom shields 105, 107 are shown, additional leads may be provided for conducting the sense current. However, such shields are not necessary and are only optional, because the shields themselves can also be used as electrodes.

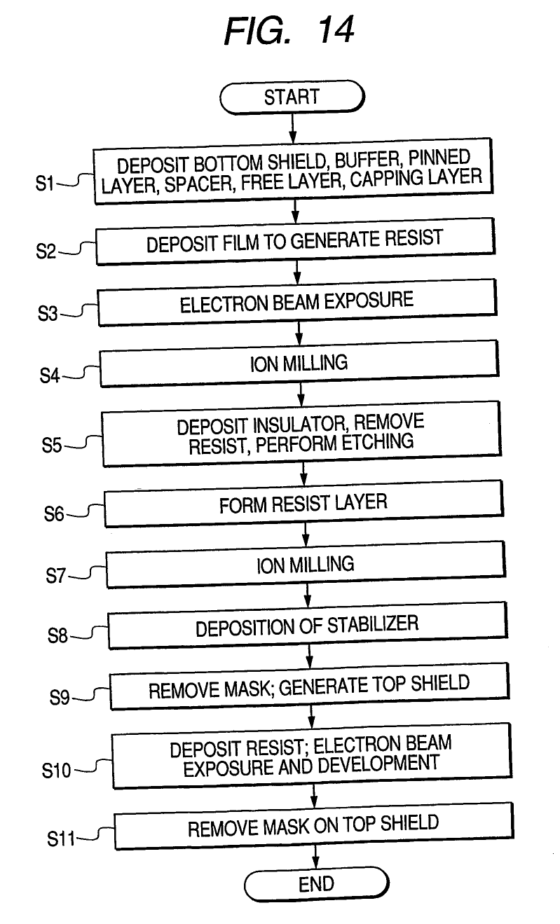

An exemplary, non-Limiting method of manufacturing the foregoing structure of the present invention will now be described, as illustrated by the flowchart in FIG. 14. The materials used in the structure are described above, and where the material used in any given part of the structure is not disclosed, it is understood that such part of the structure may be made of those materials that are well-known in the art, or equivalents thereof.

In step S1, on a wafer, films are deposited for the bottom shield 105, the buffer layer 104, the AFM layer 103, the pinned layer 102, the spacer (e.g., non-magnetic) 101, the free layer 100, and the capping layer 106.

As shown in step S2, a film is then deposited on this substrate and a resist (e.g., photoresist mask) is generated on the film. In step S3, the resulting structure is subjected to electron beam exposure followed by development of the resist to obtain the desired mask form.

Next in step S4, the resulting substrate from the foregoing process is subjected to ion milling (also referred to as ion etching), such that the area not covered by the resist is etched. An insulator is then deposited, and a lift-off step is then performed to remove the resist in step S5. In this step, etching (wet or dry) is performed to remove the excess deposited insulator above the level of the cap. However, the deposited insulator on the surface that was not part of the resist remains in this step.

Then in step S6, another resist layer subject to electron beam exposure is generated. This resist layer will form the sensor. Some portions of the resist layer have a width W that corresponds to the sensor width (preferably about 100 nm or less, but not limited thereto), and the other portions of the resist layer have a width L that corresponds to the electrode size. The electrode size is much larger than the MR element.

In step S7, ion milling is performed to produce insulation on the portions of the spin valve inside the side shields. The areas not covered by the resist are milled to form the spacer in its preferred dimensions.

Once the foregoing steps are completed, ion beam deposition (IBD) of the stabilizer is performed at step S8, using the above-noted materials. Depending on which one of the exemplary non-limiting embodiments is to be produced, step S8 will require the production of the various different layers corresponding to the stabilizer in FIGS. 8-13.

For example, but not by way of limitation, in the case of the embodiment illustrated in FIG. 8, a soft layer 110 is deposited on the insulator 108, followed by a decoupling layer 112, upon which a hard bias 113 is deposited. Additionally, in the case of the embodiment illustrated in FIG. 9, a second insulator layer 114 is deposited on the hard bias 113.

Alternatively, in the case of the embodiment illustrated in FIG. 10, the soft underlayer 115 is deposited on the insulator 108, and the hard bias 116 is then deposited on the soft underlayer 115. The soft underlayer 115 has a high permeability and serves as a buffer for the hard bias layer 116, in addition to substantially eliminating flux from adjacent tracks. The soft shield layer 118 is deposited on the hard bias 116. Optionally, as shown in FIG. 11, the second insulator 119 is deposited.

As a further alternative, in the case of the embodiment illustrated in FIG. 12, the soft layer 120 is deposited on the insulator 108, and the multi-layer structure 121 having the hard layer 122 upon which the soft layer 123 is deposited, is deposited on the soft layer 120. The number of layers in the multi-layer structure depends on factors such as the overall thickness between the top and bottom shields 105, 107 and the exchange coupling between the soft, high permeability material and the hard, high coercivity material. An underlayer may be used prior to deposition to promote crystallographic growth of the hard bias.

Optionally, as shown in FIG. 13, the decoupling layers 124 are provided between the hard layer 122 and the soft layer 123. As a result, the exchange coupling between those layers 122, 123 is reduced without substantially impacting the softness of the soft layer 123. The decoupling layer 124 can be made of an insulator so that protection from current leakage can be guaranteed.

Next at step S9, the mask is removed and the top shield is developed. A resist is then deposited on the existing substrate, followed by electron beam exposure and development in step S10. The final device is then produced, where the mask used in making the top shield is lifted in step S11.

The present invention is not limited to the specific above-described embodiments. It is contemplated that numerous modifications may be made to the present invention without departing from the spirit and scope of the invention as defined in the following claims.

### INDUSTRIAL APPLICABILITY

The present invention has various industrial applications For example, it may be used in data storage devices having a magnetic recording medium, such as hard disk drives of computing devices, multimedia systems, portable communication devices, and the related peripherals. However, the present invention is not limited to these uses, and any other use as may be contemplated by one skilled in the art may also be used.

1. A device for reading a recording medium and having a spin valve, comprising:
a magnetic sensor including,
a free layer having an adjustable magnetization direction in response to a flux received from said recording medium,
a pinned layer having a fixed magnetization stabilized in accordance with an antiferromagnetic (AFM) layer positioned on a surface of said pinned layer opposite a spacer sandwiched between said pinned layer and said free layer,
a buffer sandwiched between said AFM layer and a bottom shield that shields undesired flux at a first outer surface of said magnetic sensor, and
a capping layer sandwiched between said free layer and a top shield that shields undesired flux at a second outer surface of said magnetic sensor; and
a stabilizer including a hard bias region and a soft shield region, wherein said stabilizer is positioned on sides of said magnetic sensor and separated from said magnetic sensor by an insulator layer.

2. The device of claim 1, further comprising:
a decoupling layer positioned between said hard bias region and said soft shielding region.

3. The device of claim 2, wherein said decoupling layer comprises at least one of Al₂O₃, Si₃N₄, SiO₂, Cr, Ta, Cu and a non-magnetic material that is one of conductive and insulative.

4. The device of claim 2, wherein said soft shielding region comprises a soft shielding layer on said insulator layer, and said hard bias region comprises a hard bias layer positioned between said decoupling layer and said top shield positioned on upper surfaces of said hard bias layer, said insulator layer and said capping layer.

5. The device of claim 4, further comprising an upper insulator layer sandwiched between said hard bias layer and said top shield.

6. The device of claim 2, wherein said hard bias region comprises a hard bias layer positioned on a soft underlayer formed on said insulator layer, and said soft shielding region comprises a shielding layer positioned on said decoupling layer sandwiched between said soft shielding layer and said hard bias layer, wherein said top shield is positioned on upper surfaces of said soft shielding layer, said insulator layer and said capping layer.

7. The device of claim 6, further comprising an upper insulator layer sandwiched between said soft shielding layer and said top shield.

8. The device of claim 1, wherein said stabilizer comprises:
a soft shielding layer positioned on said insulator layer; and
a plurality of multi-layer structures, each of said multi-layer structures including a soft sublayer comprising said soft shielding region positioned on a hard sublayer comprising said hard bias region, wherein said plurality of multi-layer structures is positioned on said soft shielding layer.

9. The device of claim 8, where said hard layer in each of said plurality of multi-layer structures further comprises an upper decoupling layer positioned on an upper surface of said hard layer, and a lower decoupling layer positioned on a lower surface of said hard layer.

10. The device of claim 9, wherein said upper decoupling layer and said lower decoupling layer each comprises at least one of Al₂O₃, Si₃N₄, SiO₂, Cr, Ta, Cu and a non-magnetic-material that is one of conductive and insulative.

11. The device of claim 1, wherein said hard bias region comprises one of (a) at least one of CoPt, CoPtCr, CoPtCrB, CoPtCrAg, CoFePt, (b) a mixture of said (a) and oxygen having a concentration between about 10% and about 40%, and (c) at least one of γ-Fe₂O₃ and γ-(FeCo)₂O₃.

12. The device of claim 1, wherein said soft shielding region comprises at least one of (a) at least one of NiFe, FeSi, FeAlSi, CoZr, CoZrRe and Fe-M-B where M is at least one of a group IV-A element and a group V-A element, and (b) at least one of FeSiZr—O, FeAl—O, Fe—X—O where X is at least one of Zr and Hf, FeCoN, FeN, Fe—X—B—O, Fe—X—O where X is at least one of Zr and Hf), and FeCr—O and FeCr-M-O where M is at least one of Cu and Rh.

13. The device of claim 1, wherein said spin valve is a top type and said pinned layer is one of (a) single-layered and (b) multi-layered with a pinned layer spacer between sublayers thereof.

14. The device of claim 1, wherein said spacer is one of:
(a) an insulator spacer for use in a tunnel magnetoresistive (TMR) spin valve;
(b) a conductor for use in a giant magnetoresistive (GMR) spin valve;
(c) an insulator matrix having a magnetic nanocontact between said pinned layer and said free layer for use in a ballistic magnetoresistive (BMR) spin valve; and
(d) a mixture of a conductive and insulative material between said pinned layer and said free layer for use in a current heterogeneous spacer or current confinement path (CCP)-CPP spin valve.

15. The device of claim 14, wherein said insulator spacer comprises at least one of TaO and Al₂O₃.

16. The device of claim 14, wherein said magnetic nanocontact has a diameter of less than about 30 nm.

17. The device of claim 1, wherein said pinned layer has one of a single layer structure and a synthetic structure, and a total thickness between about 2 nm and about 10 nm.

18. The device of claim 1, wherein said free layer comprises at least one of Co, Fe, and Ni, and said free layer has a thickness of less than about 5 nm.

19. The device of claim 1, wherein at least one of said pinned layer and said free layer includes at least one of Fe₃O₄, CrO₂, NiFeSb, NiMnSb, PtMnSb, MnSb, La_{0.7}Sr_{0.3}MnO₃, Sr₂FeMoO₆, SrTiO₃, CoFeO, NiFeN, NiFeO, NiFe and CoFeN.

20. The device of claim 1, further comprising leads in said magnetic sensor for conducting a sense current of said magnetic sensor.

21. The device of claim 1, wherein a sense current of said magnetic sensor flows perpendicular to a plane of the spin-valve.

22. The device of claim 1, wherein said hard bias region and said soft shield region each has a thickness between about 1 nm and about 20 nm.

23. A method of fabricating a magnetic sensor, comprising the steps of:
on a wafer, forming a free layer having an adjustable magnetization direction in response to a flux received from a recording medium, a pinned layer having a fixed magnetization direction by exchange coupling with an antiferromagnetic (AFM) layer positioned on a surface of said pinned layer opposite a spacer sandwiched between said pinned layer and said free layer, a buffer sandwiched between said AFM layer and a bottom shield that shields undesired flux at a first outer surface of said magnetic sensor, and a capping layer on said free layer;
forming a first mask on a first region on said capping layer;
performing a first ion milling step to generate a sensor region;
depositing an insulator thereon, and removing said first mask;
forming a second mask on predetermined portions of said first region;
performing a second ion milling step to generate a shape of said magnetic sensor;
depositing a stabilizer having a hard bias region and a soft shield region onto sides of said magnetic sensor, and then removing said second mask; and
forming a top shield on said capping layer and said first stabilizing layer.

24. The method of claim 23, said depositing said stabilizer further comprising:
depositing said soft shield region on an insulator on said bottom shield;
depositing a decoupling layer on said soft shield region; and
depositing said hard bias region on said decoupling layer.

25. The method of claim 24, further comprising depositing an upper insulator layer on the hard bias region.

26. The method of claim 23, said depositing said stabilizer further comprising:
depositing a soft underlayer on an insulator on said bottom shield;
depositing said hard bias region on the soft underlayer;
depositing a decoupling layer on said hard bias region; and
depositing said soft shield region on said decoupling layer.

27. The method of claim 26, further comprising depositing an upper insulator on said soft shield region.

28. The method of claim 23, said depositing said stabilizer further comprising:
depositing a soft layer on an insulator on said bottom shield; and
forming a multi-layered structure having a hard sublayer formed on a soft shield sublayer, wherein said hard bias region comprises said hard sublayer and said soft shield region comprises said soft layer and said soft shield sublayer.

29. The method of claim 28, further comprising interposing an underlayer prior to said deposition of said stabilizer to promote crystallographic growth of the hard bias region.

30. The method of claim 28, further comprising forming at least one decoupling layer on each of an upper and a lower surface of said hard layer.

31. The method of claim 30, wherein said decoupling layer is formed by flowing oxygen between said hard layer and said soft shield layer.

32. The method of claim 23, wherein said spacer is formed as one of:
(a) an insulator for use in a tunnel magnetoresistive (TMR) spin valve;
(b) a conductor for use in a giant magnetoresistive (GMR) spin valve;
(c) an insulator matrix having a magnetic nanocontact with a diameter of less than about 30 nm formed between said pinned layer and said free layer for use in a ballistic magnetoresistive (BMR) spin valve; and
(d) a mixture of a conductive and insulative material between said pinned layer and said free layer for use in a current heterogeneous spacer or current confinement path (CCP)-CPP spin valve.

33. The method of claim 23, wherein said pinned layer has one of a single layer structure and a synthetic structure, and a total thickness between about 2 nm and about 10 nm,
said free layer is made of at least one of Co, Fe, and Ni and has a thickness of less than about 5 nm, and
at least one of said pinned layer and said free layer is made of at least one of Fe₃O₄, CrO₂, NiFeSb, NiMnSb, PtMnSb, MnSb, La_{0.7}Sr_{0.3}MnO₃, Sr₂FeMoO₆, SrTiO₃, CoFeO, NiFeN, NiFeO, NiFe and CoFeN.

34. The method of claim 23, further comprising forming leads in said top shield for conducting a sense current of said magnetic sensor.
